(19) United States
(12) Patent Application Publication
(10) Pub. No.: US 2025/0363380 A1
(43) Pub. Date: Nov. 27, 2025

(54) SYSTEMS AND METHODS FOR REINFORCEMENT LEARNING NETWORKS WITH ITERATIVE PREFERENCE LEARNING

(71) Applicant: Salesforce, Inc., San Francisco, CA (US)

(72) Inventors: Hanze Dong, Singapore (SG); Amrita Saha, Singapore (SG); Caiming Xiong, Menlo Park, CA (US); Doyen Sahoo, Singapore (SG)

(21) Appl. No.: 18/955,645

(22) Filed: Nov. 21, 2024

Related U.S. Application Data
(60) Provisional application No. 63/650,797, filed on May 22, 2024.

(51) Int. Cl. G06N 3/092; G06N 3/045; G06N 3/091

(52) U.S. Cl. CPC G06N 3/092; G06N 3/045; G06N 3/091

(57) ABSTRACT

Embodiments described herein provide a reinforcement learning framework for neural network models to generate outputs that align with desired human preference. In at least one embodiment, cross-prompts are generated from an original prompt to elicit a response from the neural network model.

### CROSS REFERENCE

This instant application is a nonprovisional of and claims priority under 35 U.S.C. 119 to U.S. provisional application No. 63/650,797, filed May 22, 2024, which is hereby expressly incorporated herein by reference in its entirety.

### TECHNICAL FIELD

The embodiments relate generally to machine learning systems for natural language processing, and more specifically to systems and methods for prompt engineering in reinforcement learning networks with human feedback for large language models (LLMs).

### BACKGROUND

AI conversation agents, commonly known as chatbots or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI conversation agents can assist with product recommendations, order tracking, and personalized shopping experiences. In information technology (IT) support, these agents can guide users through troubleshooting steps, helping them resolve software and hardware issues. Specifically, for network hazards, AI conversation agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

For some AI agents, a particular technique, known as reinforcement learning from human feedback (RLHF) has been used to train large language models (LLMs). For example, human feedback is obtained in response to a model-generation output to guide the training process, such that the language model is updated to generate outputs that align with human preferences. This approach integrates reinforcement learning with supervised learning, using human-provided data to refine model behavior iteratively. However, because the inner workings of RLHF remain relatively obscure, the trained language model may generate output responses that are not desirable, such as overly simplified, and/or the like.

Therefore, there is a need for improving AI agents to generate responses that align with human preferences.

### BRIEF DESCRIPTION OF THE DRAWINGS

FIG. 1 shows an application of an LLM based AI conversation agent, according to embodiments of the present disclosure.

FIG. 2 is a simplified diagram illustrating a training framework using augmented training data via RLHF, according to embodiments described herein.

FIGS. 3A-3F provide example prompts used to generate Catalyst prompts shown in FIG. 2, according to embodiments described herein.

FIG. 4 is a simplified diagram illustrating a computing device implementing the LLM RLHF network using cross prompts described in FIGS. 2-3, according to some embodiments.

FIG. 5 is a simplified diagram illustrating a neural network structure, according to some embodiments.

FIG. 6 is a simplified block diagram of a networked system suitable for implementing the LLM RLHF network framework described in FIGS. 1-5 and other embodiments described herein.

FIG. 7 is an example logic flow diagram illustrating a method of building an AI conversation agent to generate responses according to user preferences based on the framework shown in FIGS. 1-6, according to some embodiments described herein.

FIGS. 8A-8B show example data experiment performances of the catalyst prompting framework described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

A training technique, known as reinforcement learning from human feedback (RLHF) has been used to train large language models (LLMs). For example, human feedback is obtained in response to a model-generation output to guide the training process, such that the language model is updated to generate outputs that align with human preferences. However, because the inner workings of RLHF remain relatively obscure, the trained LLM may generate output responses that are not desirable, such as overly simplified, and/or the like.

Embodiments provide an RLHF training framework that trains LLMs using augmented catalyst prompts. Specifically, given a training dataset of prompts (but without any ground-truth response), each training prompt may be augmented, e.g., by an LLM based on different instructions, into a rewrite/extension/expansion of the original prompt, referred to as “catalyst prompts.” These catalyst prompts are then used by the LLM to iteratively generate a response via an RLHF process. For example, each catalyst prompt is assigned a positive label indicating that a corresponding response is likely desirable by users. At each time step, a loss function may be computed as a KL-distance between a probability that a desirable response is generated with the optimal parameter and a probability that a desirable response is generated with the current parameters of the LLM. The LLM is then iteratively updated by the loss function so as to generate a response to an input prompt that better supports user expectation.

In this way, with improved user preference alignment, AI conversation chatbot technology is improved.

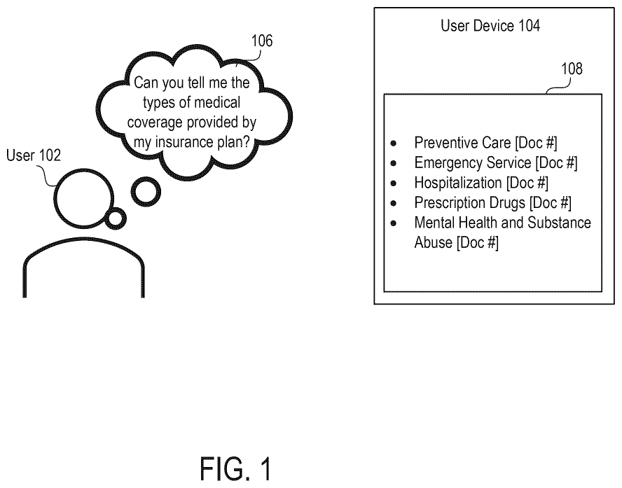

FIG. 1 shows an application 100 of an LLM based AI conversation agent, according to embodiments of the present disclosure. A user 102 may utter a query 106 in natural language. In response, a user device 104 may output/display an answer 108 on a display interface, such as a screen. In some embodiments, answer 108 is the output of an artificial intelligence (AI) chatbot, which is built on a bot server that is communicatively connected to user device 104. The chatbot may be based on, or include, an LLM. In some embodiments, the LLM receives query 106 through utterance of user 102, which may retrieve a corpus of documents, and generate an output based on the retrieved documents.

As an example, query 106 may include a question of “Can you tell me the types of medical coverage provided by my insurance plan?” The chatbot may include the query 106 in a predefined format providing instruction to the LLM how to generate a response to query 106, referred to as a “prompt,” which may be fed to an LLM as input. The LLM may in turn provide answer 108, e.g., a summary of the types of medical coverages in a predetermined format, e.g., a bullet-point format, such that one type of medical coverage is listed behind a bullet-point. In some aspects, for example, a citation of document(s) that mentioned the medical coverage is provided behind the respective bullet.

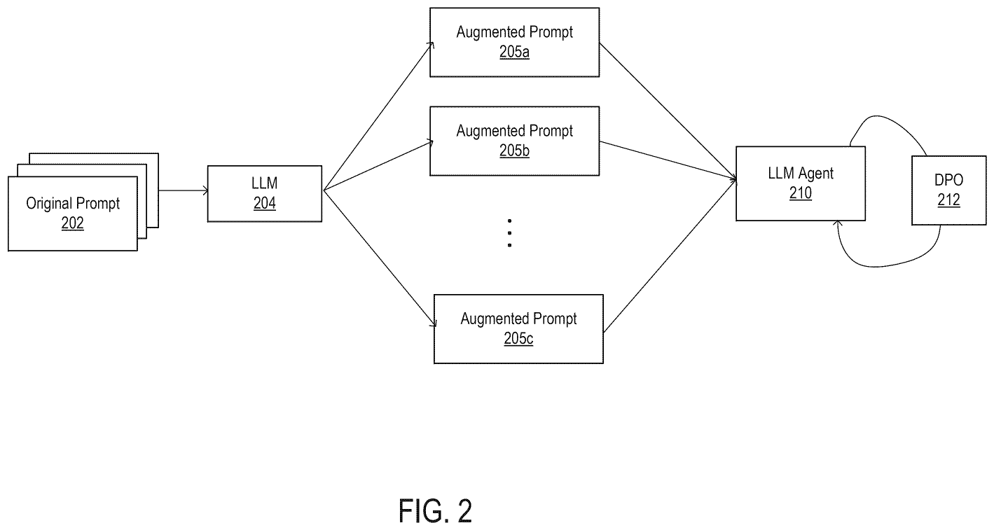

The underlying LLM may be implemented at user device 104, or at a remote server which is accessible by the user device 104. The LLM may be trained with a large corpus of texts and/or documents to provide a user desirable response as further described in FIG. 2 below.

FIG. 2 is a simplified diagram illustrating a training framework using augmented training data via RLHF, according to embodiments described herein. In one embodiment, given a corpus of training prompts 202, an LLM 210 may be used to generate a plurality of augmented. During the training process, the sampling efficiency for a specific individual prompt may be extremely low. However, as certain prompts can more easily elicit a desired behavior in the response than others, responses may be improved across multiple prompts through cross-prompt exploration.

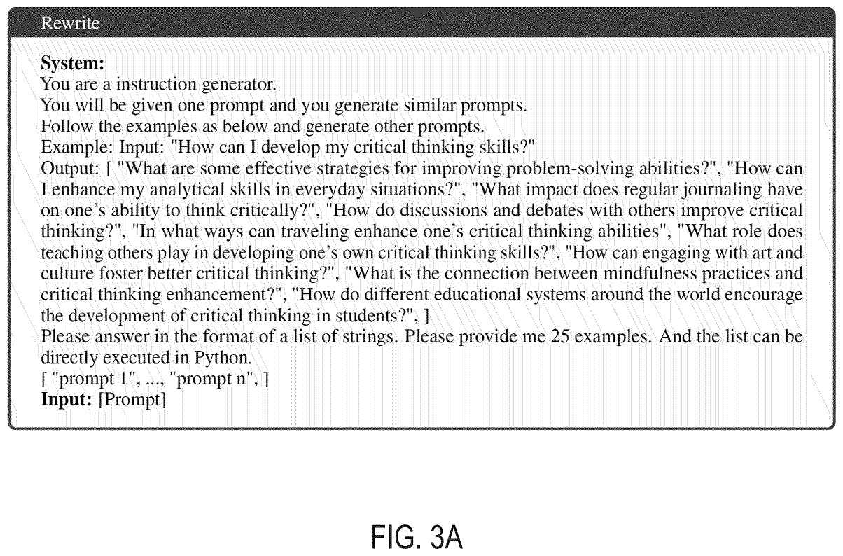

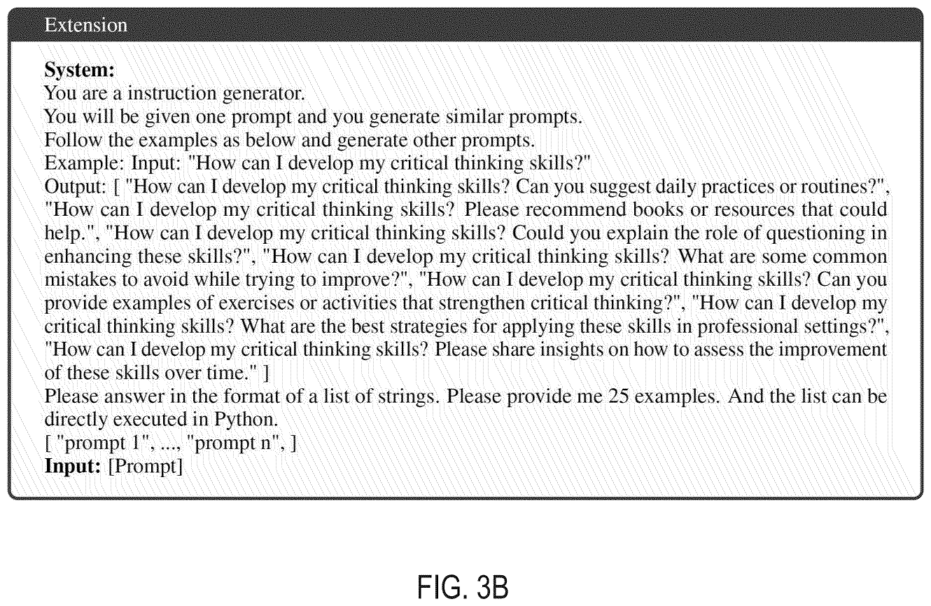

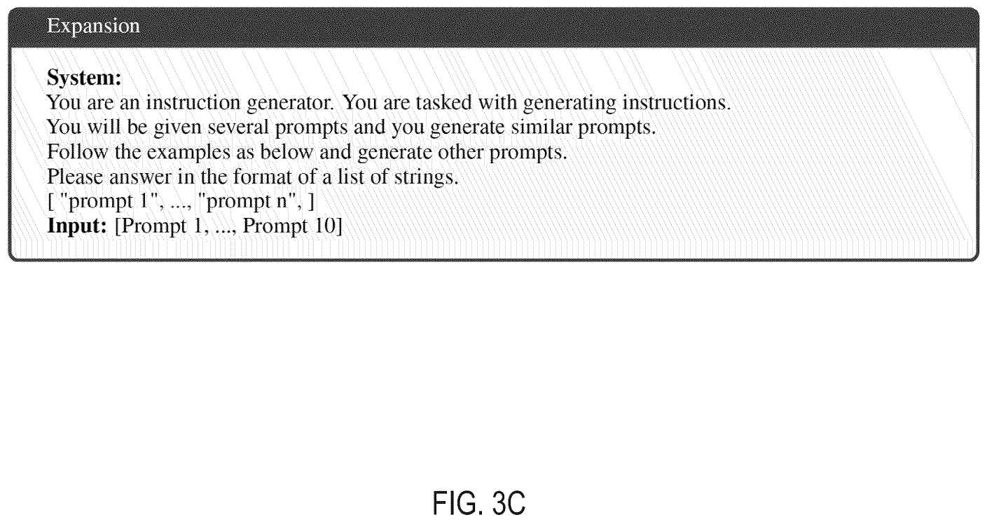

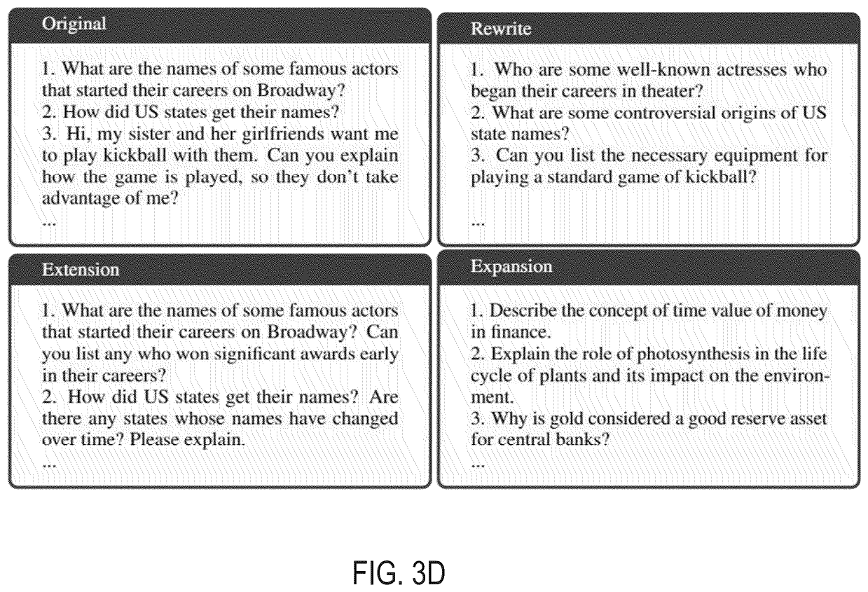

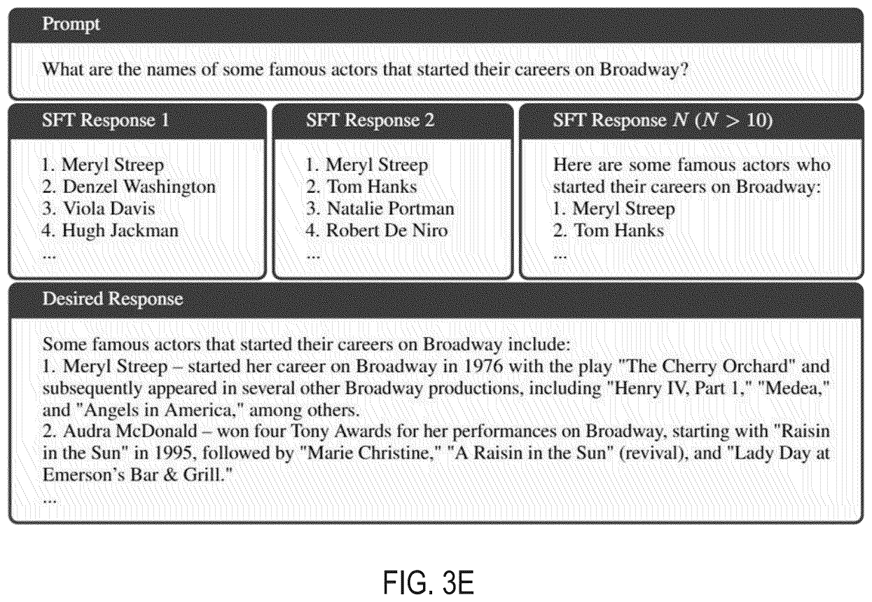

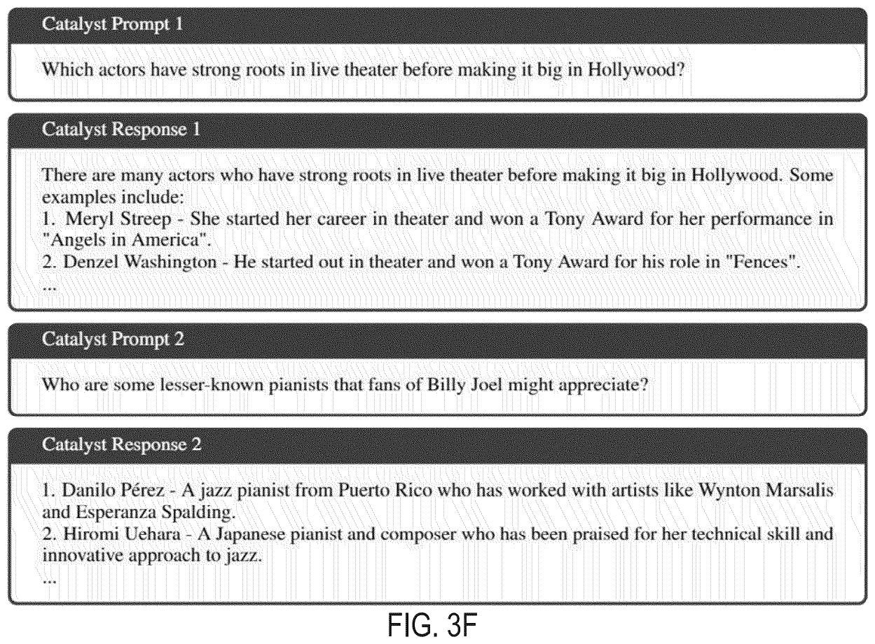

For example, LLM 204 may use different prompts to construct augmented prompts 205a-n, referred to as “catalyst prompt,” including:
1. Rewrite: paraphrasing the original prompt-an example rewrite prompt fed to LLM 204 to generate an augmented prompt of the original prompt 202 is provided in FIG. 3A.
2. Extension: elaborating on the original task instructions-an example extension prompt fed to LLM 204 to generate an augmented prompt of the original prompt 202 is provided in FIG. 3B.
3. Expansion: involving more open-ended expansion to new topics, concepts and semantics (which may not even be analogous to the original ones)-an expansion example rewrite prompt fed to LLM 204 to generate an augmented prompt of the original prompt 202 is provided in FIG. 3C.

Augmented prompts 205a-c may thus be sent to LLM agent 210 to train LLM 210 through RLHF.

In one embodiment, LLM 210 and LLM 204 may be different LLMs. In another embodiment, LLM 210 and LLM 204 may be the same LLM.

In one embodiment, given x as the prompt, a¹ and a² as responses generated by LLM 204 for prompt x, sampled from a policy model π(a|x). a¹ a² denotes the preference relation that a¹ is preferred than a². An indicator variable z to denote the preference between two responses a¹ and a²:

$$z = \{ \begin{matrix}1 & if {a}^{1} ≻ {a}^{2} \\ 0 & if {a}^{2} ≻ {a}^{1}\end{matrix} ,$$

where z=1 indicates a preference for a¹ over a², and z=0 for a² over a¹. For a¹≠a², we only observe a¹ [symbol] a² or a² [symbol] a¹. A preference oracle P: [symbol] × [symbol] × [symbol] →[0,1] determines the likelihood of a¹ being preferred over a² given x, generating z via: (z˜Bernoulli (P (a\hat{ }1 [symbol] a\hat{ }2 |x,a\hat{ }1,a\hat{ }2)), where Bernoulli (α) denotes a Bernoulli distribution with success probability α. Therefore, via reward learning, direct policy optimization (DPO) may be adopted as a method that generates samples and employs a reward model to label these samples over multiple iterations. In each iteration, the model is updated using DPO with samples from the preceding iteration.

In one embodiment, each augmented prompt 205a-c may be formulated as the input feature x=[1, x₁, x₂], where x₁ and x₂ are different prompt-dependent features, and 1 is a prompt-independent feature. The desired output is y∈{0,1}, which is just a single feature of the response space. In other words, y is a part of the response a generated by LLM 210, that can reflect the goodness of the response properties. For example, y=1 indicates that the corresponding response have the good property. y=0 indicates that the response is not desired.

In one embodiment, an evaluator, e.g., an LLM and/or human feedback, may provide whether y=1 or 0, given a response a generated by LLM 210.

In one embodiment, considering a linear predictor for y is 0, then LLM 210 may perform the label-generating process is

$$P ( y = 1 \vert x , θ ) = σ ( {x}^{⊤} θ - {c}_{y} ) . \qquad ( 1 )$$

where the initialization of the parameter is θ₀=[0,0, c], and the optimal parameter is θ_{*}=[c_{*}0,0], such that c, c_{y}=O(1). Then for the x1-induced prompt,

$$P ( y = 1 \vert [ 1 , {c}_{0 , 0} ] , {θ}_{0} ) = σ ( - {c}_{y} ) << \frac{1}{2} ,$$

indicating that some prompts can almost never induce the desired feature y=1 at initialization (the probability is nearly zero). Now under this setting, assume there are a number K of catalyst prompts

$$( e . g . , 205 a - c ) {x}_{c}^{( 1 )} , ⋯ {x}_{c}^{( K )} , where {x}_{c}^{( i )} = [ 1 , 0 , {c}_{i} ] .$$

Then the corresponding probability to produce good response at initialisation, for the i'th catalyst prompt becomes

$$P ( y = 1 \vert [ 1 , 0 , {c}_{i} ] {θ}_{0} ) = σ ( {c}_{i} c - {c}_{y} ) ,$$

which is an 0(1) chance. Therefore, for the Catalyst prompt x_c\hat{ }((i)) (e. g., 205a-c), LLM 210 may predict a probability P that y=1, e.g., the corresponding response is aligned with user preference. The loss function for

$${x}_{c}^{( i )}$$

is

$$ℓ\_i ( θ ) = KL ( P ( y = 1 ≻ y = 0 \vert {x\_c}^{⋀} ( ( i ) ) , θ\_ \text{*)} ‖ ( P ( y = 1 ≻ y = 0 \vert {x\_c}^{⋀} ( ( i ) ) , θ ) ⊣ ) . \qquad ( 2 )$$

which may be used to iteratively update LLM 210 via direct policy optimization (DPO) 212. Thus, by leveraging these catalyst prompts 205a-c, LLM 205 may be trained to generate well-behaved responses for all the prompts. In other words, for Catalyst prompts

$${x}_{c}^{( 1 )} , … , {x}_{c}^{( K )} ,$$

with both y=0 and y=1 responses for each prompt, minimizing the loss function θ^{(K)} satisfies

$$P ( ‖ {θ}^{( K )} - {θ}_{*} ‖ > ϵ ) \to 0 in probability for any ϵ > 0. \qquad ( 3 )$$

That means the parameter θ will converge to [c*, 0, 0] by increasing the number of Catalyst prompts. Thus, finally, even for x1-induced prompt,

$$P ( y = 1 \vert [ 1 , {c}_{0 , 0} ] {θ}_{*} ) = σ ( {c}_{*} - {c}_{y} ) ,$$

which is a 0(1) chance. Thus, by providing the sufficiently many Catalyst Prompts 205a-c and minimize the loss function, LLM 210 may be trained via direct policy optimization (DPO) 212 to generate good responses that align with user preference to all the prompts.

FIGS. 3A-3C provide example prompts used for LLM 210 to generate Catalyst prompts 205a-205c.

FIG. 3D is a simplified diagram illustrating an example use case of LLM generated responses using an LLM trained with supervised fine tuning (SFT), according to some embodiments. LLM chat models trained with RLHF training algorithms may generate output responses that are not desirable, such as overly simplified, and/or the like, due to a lack of understanding of the inner workings of RLHF.

For example, as shown in FIG. 3D, given an input prompt (e.g., an example taken from the AlpacaEval test set), an SFT LLM model may emery generate minimal and overly simplified response, after multiple rounds of generation attempts. To end up with a more detailed response that aligns with human expectation, a large number of samples are usually required to produce detailed and engaging responses, e.g., with follow up prompts such as “how did Meryl Streep start her career on Broadway?” This process can be repetitive and inefficient, showing limited exploration when generating from the original prompt.

FIG. 3D shows that response generated by pretrained models that have only undergone SFT may be consistently unsatisfactory, particularly before the RL phase. For example, a supervised fine-tuned (SFT) model is often initialized, pretrained and finetuned, yet it remains difficult to elicit a high-quality response. The resulting responses do not include explanations or background context, offering only minimal answers. As shown in FIG. 1, even after generating more than ten samples, obtaining a satisfactory response remains challenging, complicating the RLHF process due to the scarcity of quality positive samples.

FIG. 3E is a simplified example illustrating examples of catalyst prompt inputs and corresponding LLM outputs, according to some embodiments described herein. In the context of iterative preference learning (as described in Sec. 2.1 in Appendix I), cross prompts may be formulated as task instructions across different task domains. For example, the input feature of an input prompt may comprise different prompt-dependent features, and a prompt-independent features. The desired output feature may then be formulated as a binary label y{0, 1}. Then for prompt that is induced by a specific prompt-dependent feature, some prompts may almost never induce the desired feature y=1. In this setting, some catalyst prompts may be designed to enhance the corresponding probability to produce a good response.

Compared with the prompt in FIG. 3D, catalyst prompts in FIG. 3E provides an example that induces responses with proper semantic relevance. Catalyst Prompt 1 is semantically similar to the original prompt. Unlike the original prompt, this form significantly enhances the responses of the policy model, making them more detailed and complete. This improvement allows the model to better learn features and expressions aligned with human preferences, such as elaborating on details, providing explanations and annotations, and adding connecting sentences.

In one embodiment, even though Catalyst Prompt 2 is not semantically related to Catalyst Prompt 1, the model can still learn high-quality response characteristics. Both prompts involve descriptions, and explanations of different people. This capability makes cross-prompt exploration particularly intriguing and efficient, enabling rapid improvement during the model's RLHF process.

FIG. 3F shows additional example catalyst prompts and the resulting responses, according to embodiments described herein.

### Computer and Network Environment

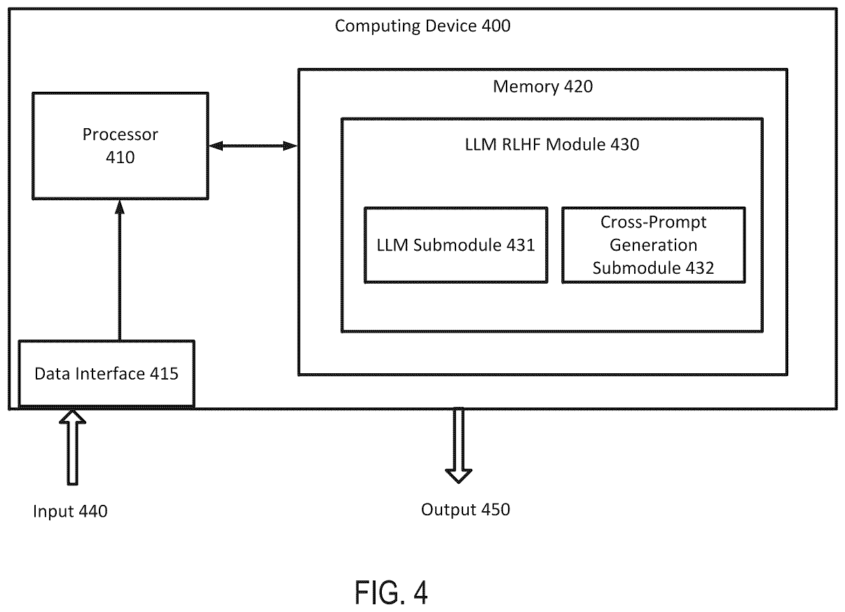

FIG. 4 is a simplified diagram illustrating a computing device implementing the LLM RLHF network using cross prompts described in FIGS. 2-3, according to some embodiments. As shown in FIG. 4, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

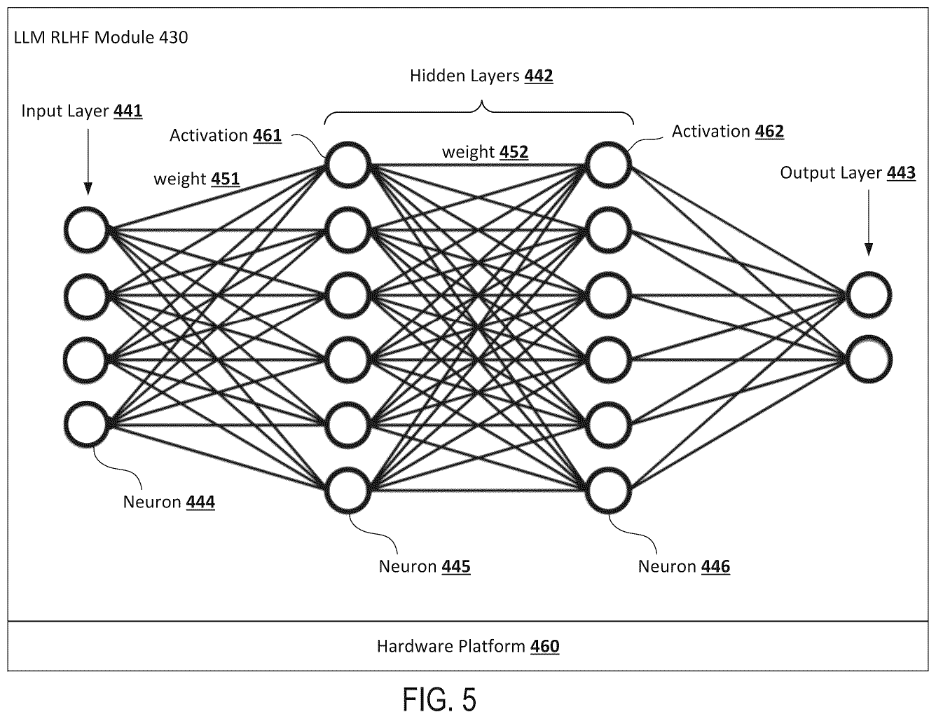

In another embodiment, processor 410 may comprise multiple microprocessors and/or memory 420 may comprise multiple registers and/or other memory elements such that processor 410 and/or memory 420 may be arranged in the form of a hardware-based neural network, as further described in FIG. 5.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for LLM RLHF module 430 that may be used to implement and/or emulate the systems and models, and/or to implement any of the methods described further herein. LLM RLHF module 430 may receive input 440 such as an input training data (e.g., training samples of questions) via the data interface 415 and generate an output 450 which may be a response.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as a text question, from a user via the user interface.

In some embodiments, the LLM RLHF module 430 is configured to train an LLM using cross prompts as described herein and in Appendix I. The LLM RLHF module 430 may further include an LLM submodule 431 and a cross prompt generation submodule 432 to generate cross prompts as described herein and in Appendix I.

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 5 is a simplified diagram illustrating the neural network structure implementing the LLM RLHF module 430 described in FIG. 4A, according to some embodiments. In some embodiments, the LLM RLHF module 430 and/or one or more of its submodules 431-432 may be implemented at least partially via an artificial neural network structure shown in FIG. 5. The neural network comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data (e.g., 440 in FIG. 4A), such as a text question. The number of nodes (neurons) in the input layer 441 may be determined by the dimensionality of the input data (e.g., the length of a vector of a text question). Each node in the input layer represents a feature or attribute of the input.

The hidden layers 442 are intermediate layers between the input and output layers of a neural network. It is noted that two hidden layers 442 are shown in FIG. 4B for illustrative purpose only, and any number of hidden layers may be utilized in a neural network structure. Hidden layers 442 may extract and transform the input data through a series of weighted computations and activation functions.

For example, as discussed in FIG. 4, the LLM RLHF module 430 receives an input 440 of a text question and transforms the input into an output 450 of a response. To perform the transformation, each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the LLM RLHF module 430 and/or one or more of its submodules 431-432 may comprise the transformative neural network structure of layers of neurons, and weights and activation functions describing the non-linear transformation at each neuron. Such a neural network structure is often implemented on one or more hardware processors 410, such as a graphics processing unit (GPU). An example neural network may be a transformer based LLM, and/or the like.

In one embodiment, the LLM RLHF module 430 and its submodules 431-?? may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input token to be processed through the multiple layers to generate an output in a Transformer architecture often entail hundreds of teraflops (trillions of floating-point operations) of computation.

In one embodiment, the LLM RLHF module 430 and its submodules 431-432 may be implemented by hardware, software and/or a combination thereof. For example, the LLM RLHF module 430 and its submodules 431-432 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

In another embodiment, some or all of layers 441, 442, 443 and/or neurons 442, 445, 446, and operations there between such as activations 461, 462, and/or the like, of the LLM RLHF module 430 and its submodules 431-432 may be realized via one or more ASICs. For example, each neuron 442, 445 and 446 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the LLM RLHF module 430 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based LLM RLHF module 430 and one or more of its submodules 431-432 may be trained by iteratively updating the underlying parameters (e.g., weights 451, 452, etc., bias parameters and/or coefficients in the activation functions 461, 462 associated with neurons) of the neural network based on the loss. For example, during forward propagation, the training data such as text questions are fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth” such as the corresponding desired answer to the question) from the training data, to compute a loss function that measures the discrepancy between the predicted output and the expected output. For example, the loss function may be cross entropy, MMSE, or according to loss function in Sec. 2.2 of Appendix I. Given the loss, the negative gradient of the loss function is computed with respect to each weight of each layer individually. Such negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

In one embodiment, the neural network based LLM RLHF module 430 and one or more of its submodules 431-432 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning-in other words, backward propagation and forward propagation may occur for both “training” and “inference” stages of the neural network mode.

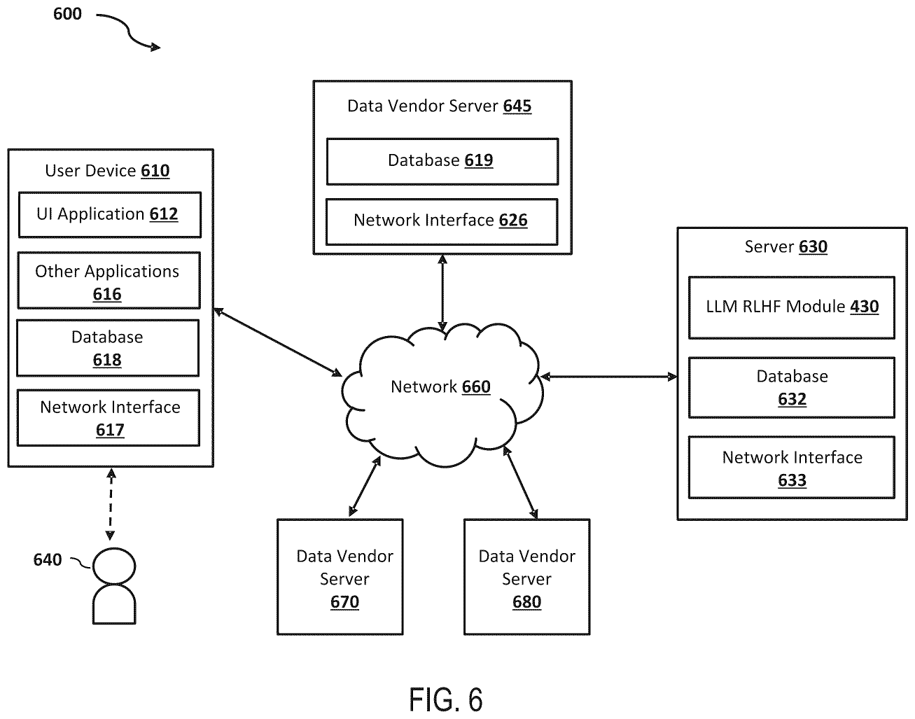

In one embodiment, LLM RLHF module 430 and its submodules 431-432 may be housed at a centralized server (e.g., computing device 400) or one or more distributed servers. For example, one or more of LLM RLHF module 430 and its submodules 431-432 may be housed at external server(s). The different modules may be communicatively coupled by building one or more connections through application programming interfaces (APIs) for each respective module. Additional network environment for the distributed servers hosting different modules and/or submodules may be discussed in FIG. 6.

During a backward pass, parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as generate content description in response to an input request.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in generative AI chat agents.

FIG. 6 is a simplified block diagram of a networked system 600 suitable for implementing the LLM RLHF framework described in FIGS. 1-5 and other embodiments described herein. In one embodiment, system 600 includes the user device 610 which may be operated by user 640, data vendor servers 645, 670 and 680, server 630, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4A, operating an OS such as a MICROSOFT® OS, a UNIX® OS, a LINUX® OS, or other suitable device and/or server-based OS. It can be appreciated that the devices and/or servers illustrated in FIG. 6 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 610, data vendor servers 645, 670 and 680, and the server 630 may communicate with each other over a network 660. User device 610 may be utilized by a user 640 (e.g., a driver, a system admin, etc.) to access the various features available for user device 610, which may include processes and/or applications associated with the server 630 to receive an output data anomaly report.

User device 610, data vendor server 645, and the server 630 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 600, and/or accessible over network 660.

User device 610 may be implemented as a communication device that may utilize appropriate hardware and software configured for wired and/or wireless communication with data vendor server 645 and/or the server 630. For example, in one embodiment, user device 610 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 610 of FIG. 6 contains a user interface (UI) application 612, and/or other applications 616, which may correspond to executable processes, procedures, and/or applications with associated hardware. For example, the user device 610 may receive a message indicating a response from the server 630 and display the message via the UI application 612. In other embodiments, user device 610 may include additional or different modules having specialized hardware and/or software as required.

In one embodiment, UI application 612 may communicatively and interactively generate a UI for an AI agent implemented through the LLM RLHF module 430 (e.g., an LLM agent) at server 630. In at least one embodiment, a user operating user device 610 may enter a user utterance, e.g., via text or audio input, such as a question, uploading a document, and/or the like via the UI application 612. Such user utterance may be sent to server 630, at which LLM RLHF module 430 may generate a response via the process described in FIGS. 1-5. The LLM RLHF module 430 may thus cause a display of a response at Ul application 612 and interactively update the display in real time with the user utterance.

In various embodiments, user device 610 includes other applications 616 as may be desired in particular embodiments to provide features to user device 610. For example, other applications 616 may include security applications for implementing client-side security features, programmatic client applications for interfacing with appropriate application programming interfaces (APIs) over network 660, or other types of applications. Other applications 616 may also include communication applications, such as email, texting, voice, social networking, and IM applications that allow a user to send and receive emails, calls, texts, and other notifications through network 660. For example, the other application 616 may be an email or instant messaging application that receives a prediction result message from the server 630. Other applications 616 may include device interfaces and other display modules that may receive input and/or output information. For example, other applications 616 may contain software programs for asset management, executable by a processor, including a graphical user interface (GUI) configured to provide an interface to the user 640 to view the generated response.

User device 610 may further include database 618 stored in a transitory and/or non-transitory memory of user device 610, which may store various applications and data and be utilized during execution of various modules of user device 610. Database 618 may store user profile relating to the user 640, predictions previously viewed or saved by the user 640, historical data received from the server 630, and/or the like. In some embodiments, database 618 may be local to user device 610. However, in other embodiments, database 618 may be external to user device 610 and accessible by user device 610, including cloud storage systems and/or databases that are accessible over network 660.

User device 610 includes at least one network interface component 617 adapted to communicate with data vendor server 645 and/or the server 630. In various embodiments, network interface component 617 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 645 may correspond to a server that hosts database 619 to provide training datasets including question-answering pairs to the server 630. The database 619 may be implemented by one or more relational database, distributed databases, cloud databases, and/or the like.

The data vendor server 645 includes at least one network interface component 626 adapted to communicate with user device 610 and/or the server 630. In various embodiments, network interface component 626 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 645 may send asset information from the database 619, via the network interface 626, to the server 630.

The server 630 may be housed with the LLM RLHF module 430 and its submodules described in FIG. 4A. In some implementations, LLM RLHF module 430 may receive data from database 619 at the data vendor server 645 via the network 660 to generate responses. The generated responses may also be sent to the user device 610 for review by the user 640 via the network 660.

The database 632 may be stored in a transitory and/or non-transitory memory of the server 630. In one implementation, the database 632 may store data obtained from the data vendor server 645. In one implementation, the database 632 may store parameters of the LLM RLHF module 430. In one implementation, the database 632 may store previously generated responses, and the corresponding input feature vectors.

In some embodiments, database 632 may be local to the server 630. However, in other embodiments, database 632 may be external to the server 630 and accessible by the server 630, including cloud storage systems and/or databases that are accessible over network 660.

The server 630 includes at least one network interface component 633 adapted to communicate with user device 610 and/or data vendor servers 645, 670 or 680 over network 660. In various embodiments, network interface component 633 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 660 may be implemented as a single network or a combination of multiple networks. For example, in various embodiments, network 660 may include the Internet or one or more intranets, landline networks, wireless networks, and/or other appropriate types of networks. Thus, network 660 may correspond to small scale communication networks, such as a private or local area network, or a larger scale network, such as a wide area network or the Internet, accessible by the various components of system 600.

### Example Work Flows

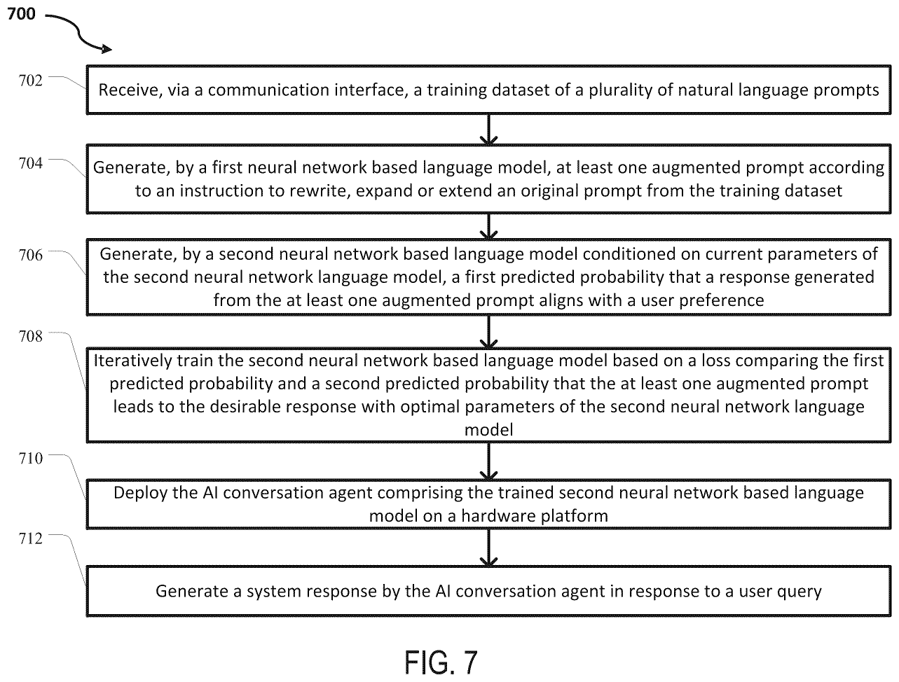

FIG. 7 is an example logic flow diagram illustrating a method of building an artificial intelligence (AI) conversation agent to generate responses according to user preferences based on the framework shown in FIGS. 1-6, according to some embodiments described herein. One or more of the processes of method 700 may be implemented, at least in part, in the form of executable code stored on non-transitory, tangible, machine-readable media that when run by one or more processors may cause the one or more processors to perform one or more of the processes. In some embodiments, method 700 corresponds to the operation of the LLM RLHF module 430 (e.g., FIGS. 4-6) that performs training and building an artificial intelligence (AI) conversation agent.

As illustrated, the method 700 includes a number of enumerated steps, but aspects of the method 700 may include additional steps before, after, and in between the enumerated steps. In some aspects, one or more of the enumerated steps may be omitted or performed in a different order.

At step 702, a training dataset of a plurality of natural language prompts (e.g., 202 in FIG. 2) may be received, via a communication interface (e.g., 415 in FIG. 4).

At step 704, a first neural network based language model (e.g., LLM 204 in FIG. 2) may generate at least one augmented prompt (e.g., 205a-c in FIG. 2) according to an instruction to rewrite, expand or extend an original prompt from the training dataset. For example, the at least one augmented prompt contains at least one or more different words from words in the original prompt that paraphrase the original prompt.

In one implementation, the at least one augmented prompt contains at least one or more words in addition to the original prompt that adds additional instruction relating to a task contained to the original prompt.

In one implementation, the at least one augmented prompt contains at least one or more words relating to one or more new topics, concepts or semantics not preexisting in the original prompt.

In one implementation, the at least one augmented prompt contains at least one or more words relating to one or more new topics, concepts or semantics not preexisting in the original prompt.

At step 706, a second neural network based language model (e.g., LLM 210 in FIG. 2) conditioned on current parameters of the second neural network language model may generate a first predicted probability that a response generated from the at least one augmented prompt aligns with a user preference. For example, the second neural network based language model comprise a generation model that generates the response based an input of the at least one augmented prompt, and an evaluator model that generates the first predicted probability based on the response. The input to the second neural network based language model takes a form of one or more prompt dependent features and one or more prompt independent features.

At step 708, the second neural network based language model may be iteratively trained based on a loss comparing the first predicted probability and a second predicted probability that the at least one augmented prompt leads to the desirable response with optimal parameters of the second neural network language model. For example, the loss is obtained through a plurality of augmented prompts generated from the training dataset.

At step 710, the AI conversation agent comprising the trained second neural network based language model may be deployed on a hardware platform (e.g., 460 in FIG. 5). For example, a target hardware with suitable processing power, memory, and battery life for the AI agent, such as edge devices (Raspberry Pi, NVIDIA Jetson) or microcontrollers for lighter tasks may be selected. Through optimization methods like quantization, pruning, or model distillation, which helps in fitting resource constraints of the hardware, the optimized neural network language model may be loaded onto the selected hardware device, integrated with software libraries.

At step 712, a system response (e.g., 108 in FIG. 1) may be generated by the AI conversation agent in response to a user query. For example, the user query is augmented according to an instruction to rewrite, expand or extend to generate the system response.

In one embodiment, method 700 is applicable in a variety of applications. For example, the user query received by a neural network model may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 700, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing method 700 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

### Data Experiments

In an example experiment setting, GPT-4-turbo may be adopted as oracle evaluator simulating human preference. Win-rate is compared against GPT-4-turbo or ask GPT-4-turbo to give the score to model's responses. Zephyr-7B-SFT may be used as an initial SFT model and perform RLHF on it. It is a finetuned version of Mistral-7B-v0.1 on open-source Ultra-Chat SFT dataset with 200K high-quality samples. GPT-4-turbo may be adopted (e.g., as LLM 204) to generate 20K Catalyst prompts, following each of the prescribed techniques, from the 805 original prompts in AlpacaEval benchmark. For each setting, iterative DPO is conducted for 3 iterations. For each iteration, 2 epochs are conducted on 20K prompts. The batch size is 32. The learning rate is 1×10−7 with 3% warm-up steps. Hardware platform (e.g., 460 in FIG. 5) for deployment may comprise 8× NVIDIA A100-SXM4-40GB with deepspeed ZeRO-3 strategy. For each input prompt, 8 candidate samples are generated and use UltraRM-13B for preference labeling. The best-of-8 and worst-of-8 pair are used to perform the iterative DPO.

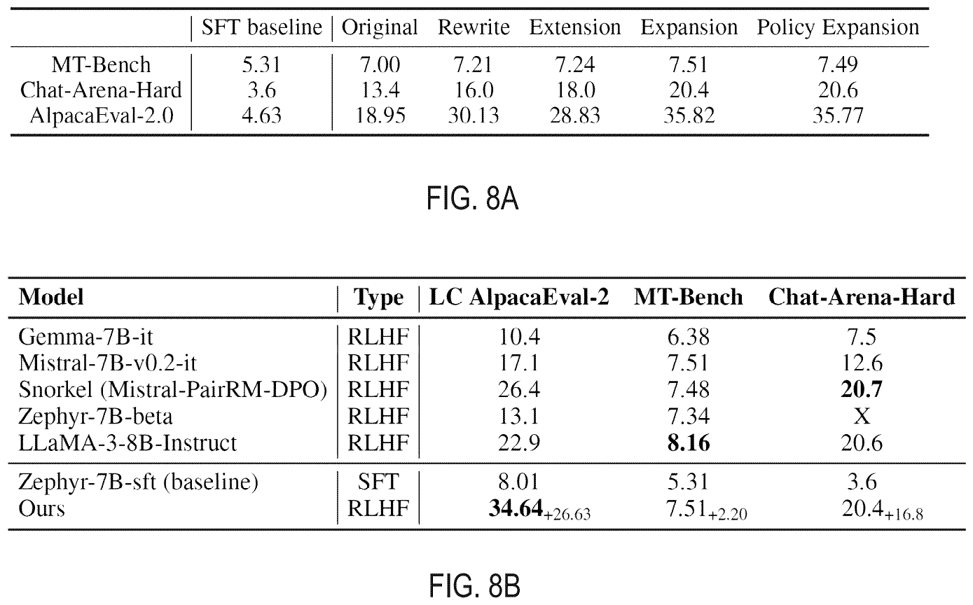

As shown in Table 1 of FIG. 8A, performing RLHF on AlpacaEval can still generalize well on other benchmarks, such as MT-Bench and Chat-Arena-Hard. Table 1 provides a detailed comparison of these benchmarks, demonstrating that they align well in terms of agreement. The optimized model using LLM RLHF module 430 shows a significant improvement over the baseline, with again “expansion” strategy emerging as most effective. Further, in a separate setting where the Catalyst Prompts are generated using “expansion” by the policy model itself instead of GPT-4-turbo. The column ‘Policy Expansion’ in Table 1 demonstrates that using the policy-model instead of a more powerful model still leads to equally effective catalyst prompts.

One notable aspect is that these three benchmarks have very different prompt distributions. However, despite these differences, all three benchmarks can be improved significantly. Therefore, Catalyst prompts induced by AlpacaEval can also enhance the responses to other prompts in unrelated domains.

Table 2 of FIG. 8B further prove that the technique of tuning with Catalyst Prompts can be very competitive with the current leading RLHF 282 tuned 7-8B models. Zephyr-7B-beta is the official DPO version of Zephyr-7B-sft. Mistral-7B-v0.2-it 283 is also an RLHF version based on Mistral-v0.1. Snorkel (Mistral-PairRM-DPO) is the iterative DPO version of Mistral-7B-v0.2-it. Note that the baseline Zephyr-SFT-7B is originally worse than Snorkel, Gemma-7B-it and LLaMA-3-8B-Instruct which are all competitive 7-8B model with 286 full (private) RLHF procedure. But with the RL tuning with Catalyst Prompts, it attains performance at-par to them, or even superseding them in some cases.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of building an artificial intelligence (AI) conversation agent to generate responses according to user preferences, the method comprising:
receiving, via a communication interface, a training dataset of a plurality of natural language prompts;
generating, by a first neural network based language model, at least one augmented prompt according to an instruction to rewrite, expand or extend an original prompt from the training dataset;
generating, by a second neural network based language model conditioned on current parameters of the second neural network language model, a first predicted probability that a response generated from the at least one augmented prompt aligns with a user preference;
iteratively training the second neural network based language model based on a loss comparing the first predicted probability and a second predicted probability that the at least one augmented prompt leads to the desirable response with optimal parameters of the second neural network language model;
deploying the AI conversation agent comprising the trained second neural network based language model on a hardware platform; and
generating a system response by the AI conversation agent in response to a user query.

2. The method of claim 1, wherein the at least one augmented prompt contains at least one or more different words from words in the original prompt that paraphrase the original prompt.

3. The method of claim 1, wherein the at least one augmented prompt contains at least one or more words in addition to the original prompt that adds additional instruction relating to a task contained to the original prompt.

4. The method of claim 1, wherein the at least one augmented prompt contains at least one or more words relating to one or more new topics, concepts or semantics not preexisting in the original prompt.

5. The method of claim 1, wherein the second neural network based language model comprise a generation model that generates the response based an input of the at least one augmented prompt, and an evaluator model that generates the first predicted probability based on the response.

6. The method of claim 5, wherein the input to the second neural network based language model takes a form of one or more prompt dependent features and one or more prompt independent features.

7. The method of claim 1, wherein the loss is obtained through a plurality of augmented prompts generated from the training dataset.

8. The method of claim 1, wherein the user query is augmented according to an instruction to rewrite, expand or extend to generate the system response.

9. A system of building an artificial intelligence (AI) conversation agent to generate responses according to user preferences, the system comprising:
a communication interface receiving a training dataset of a plurality of natural language prompts;
a memory storing a plurality of processor-executable instructions; and
a processor executing the plurality of processor-executable instructions to perform operations comprising:
generating, by a first neural network based language model, at least one augmented prompt according to an instruction to rewrite, expand or extend an original prompt from the training dataset;
generating, by a second neural network based language model conditioned on current parameters of the second neural network language model, a first predicted probability that a response generated from the at least one augmented prompt aligns with a user preference;
iteratively training the second neural network based language model based on a loss comparing the first predicted probability and a second predicted probability that the at least one augmented prompt leads to the desirable response with optimal parameters of the second neural network language model;
deploying the AI conversation agent comprising the trained second neural network based language model on a hardware platform; and
generating a system response by the AI conversation agent in response to a user query.

10. The system of claim 9, wherein the at least one augmented prompt contains at least one or more different words from words in the original prompt that paraphrase the original prompt.

11. The system of claim 9, wherein the at least one augmented prompt contains at least one or more words in addition to the original prompt that adds additional instruction relating to a task contained to the original prompt.

12. The system of claim 9, wherein the at least one augmented prompt contains at least one or more words relating to one or more new topics, concepts or semantics not preexisting in the original prompt.

13. The system of claim 9, wherein the second neural network based language model comprise a generation model that generates the response based an input of the at least one augmented prompt, and an evaluator model that generates the first predicted probability based on the response.

14. The system of claim 13, wherein the input to the second neural network based language model takes a form of one or more prompt dependent features and one or more prompt independent features.

15. The system of claim 9, wherein the loss is obtained through a plurality of augmented prompts generated from the training dataset.

16. The system of claim 9, wherein the user query is augmented according to an instruction to rewrite, expand or extend to generate the system response.

17. A non-transitory processor-readable medium storing a plurality of processor-executable instructions of building an artificial intelligence (AI) conversation agent to generate responses according to user preferences, the instructions being executed by one or more processors to perform operations comprising:
receiving, via a communication interface, a training dataset of a plurality of natural language prompts;
generating, by a first neural network based language model, at least one augmented prompt according to an instruction to rewrite, expand or extend an original prompt from the training dataset;
generating, by a second neural network based language model conditioned on current parameters of the second neural network language model, a first predicted probability that a response generated from the at least one augmented prompt aligns with a user preference;
iteratively training the second neural network based language model based on a loss comparing the first predicted probability and a second predicted probability that the at least one augmented prompt leads to the desirable response with optimal parameters of the second neural network language model;
deploying the AI conversation agent comprising the trained second neural network based language model on a hardware platform; and
generating a system response by the AI conversation agent in response to a user query.

18. The non-transitory processor-readable medium of claim 17, wherein the at least one augmented prompt contains any of:
at least one or more different words from words in the original prompt that paraphrase the original prompt, at least one or more words in addition to the original prompt that adds additional instruction relating to a task contained to the original prompt, or at least one or more words relating to one or more new topics, concepts or semantics not preexisting in the original prompt.

19. The non-transitory processor-readable medium of claim 17, wherein the second neural network based language model comprise a generation model that generates the response based an input of the at least one augmented prompt, and an evaluator model that generates the first predicted probability based on the response.

20. The non-transitory processor-readable medium of claim 19, wherein the input to the second neural network based language model takes a form of one or more prompt dependent features and one or more prompt independent features.
